(19) United States
(12) Patent Application Publication
(10) Pub. No.: US 2009/0324142 A1
(43) Pub. Date: Dec. 31, 2009

(54) PACKAGING MATERIAL AND BAG FOR PACKAGING OF MEDICINAL PRODUCT

(75) Inventors: Hiroyuki Nishikawa, Osaka (JP); Makoto Yamazaki, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: TOYO ALUMINIUM KABUSHIKI KAISHA, Osaka-shi, Osaka (JP); SASAKI CHEMICAL CO., LTD., Kyoto-shi, Kyoto (JP)

(21) Appl. No.: 12/304,567

(22) PCT Filed: Jun. 15, 2007
(86) PCT No.: PCT/JP2007/062123

§ 371 Date: May 21, 2009

(30) Foreign Application Priority Data
Jun. 16, 2006 (JP) 2006-167757

(51) Int. Cl. B65D 33/00; B32B 3/26

(52) U.S. Cl. 383/105; 428/304.4

(57) ABSTRACT

The present invention provides a bag for packaging medicinal product or a packaging material having excellent long-term storage stability. Specifically, the present invention provides a packaging material that comprises at least a moisture-permeable layer, a moisture-absorption layer, and a shielding layer laminated sequentially, wherein: (1) the moisture-absorption layer is formed of a first composition comprising a moisture absorbent and a resin component; (2) the moisture-permeable layer is formed of a second composition comprising a resin component; and (3) the first composition contains a moisture absorbent in a proportion of 15 wt. % to 60 wt. %.

### TECHNICAL FIELD

The present invention relates to a packaging material and a bag for packaging a medicinal product.

### BACKGROUND ART

Among medicinal products, patches (agents for patches) in particular have features exhibiting drug efficacy sustainability, ease of medication administration, etc., and are used against various diseases to suppress inflammation, treat cardiopathies, etc.

Medicament components of a patch are absorbed through skin or mucous membranes (percutaneous absorption), and are passed through blood vessels or lymph vessels to reach the disease site, and exert the desired therapeutic efficacy therein. However, it is known that exposure to air causes the deterioration of the release performance (the sustained release) of a patch due to the deposition, etc. of the medicament component thereof. For this reason, it is necessary to improve the long-term storage stability of patches to maintain their performance level.

Patent Document 1 proposes a packaging bag for a patch comprising packaging material that has saturation moisture absorption of 2 to 30 g/m² under the conditions of a 25° C. temperature and a relative humidity of 75%. Such a packaging material comprises a moisture-absorption layer, which comprises a first resin containing a moisture absorbent in an amount of 20 wt. % to 40 wt. %. The moisture-absorption layer is disposed between a water-permeable layer, which comprises a second resin and has a moisture permeability of 40 to 120 g/m²/day, and a shielding layer, which blocks the transmission of moisture and light. The thus-arranged packaging material is formed into a bag in such a manner that the water-permeable layers are disposed inside of the bag.

Patent Document 1: Japanese Unexamined Patent Publication No. 2001-9985

### DISCLOSURE OF THE INVENTION

### Problems to be Solved by the Invention

The aforesaid packaging bag for a patch has been improved to some extent in terms of long-term storage stability; however, further improvements may be made therefor.

The main object of the present invention is to provide a packaging bag for a medicinal product, or a packaging material, having excellent long-term storage stability.

### Means for Solving the Problems

In view of the current state of the prior art, the present inventors conducted intensive research and found that the above object can be achieved by employing a specific material to form a layer structure. The present invention is accomplished based on such findings.

Specifically, the present invention relates to the following packaging material and bag for packaging a medicinal product.

Item 1. A packaging material comprising at least a moisture-permeable layer, a moisture-absorption layer, and a shielding layer laminated sequentially, wherein:

(1) the moisture-absorption layer is formed of a first composition comprising a moisture absorbent and a resin component;

(2) the moisture-permeable layer is formed of a second composition comprising a resin component; and

(3) the first composition contains a moisture absorbent in a proportion of 15 wt. % to 60 wt. %.

Item 2. The packaging material according to Item 1, having a moisture absorption property of an equilibrium humidity from 25% to 35% RH at a temperature of 25° C.

Item 3. The packaging material according to Item 1, wherein the resin component of the first composition is a low-density polyethylene.

Item 4. The packaging material according to Item 1, wherein the resin component of the second composition is polyacrylonitrile.

Item 5. The packaging material according to Item 1, wherein the moisture-absorption layer has a thickness of 10 μm to 80 μm.

Item 6. The packaging material according to Item 1, wherein the moisture-permeable layer has a thickness of from 10 μm to 40 μm.

Item 7. A bag for packaging a medicinal product, comprising the packaging material according to Item 1, wherein the packaging material is formed into a bag in such a manner that the moisture-permeable layer is disposed on the inside of the bag.

Item 8. The bag for packaging a medicinal product according to Item 7, wherein the packaging material is heat-sealed to form a bag.

Item 9. The bag for packaging a medicinal product according to Item 8, wherein the heat-seal strength is from 5 N/15 mm to 20 N/15 mm.

Item 10. A packaged medicinal product, wherein the bag for packaging a medicinal product according to Item 7 stores a medicinal product containing a medicinal component.

Item 11. A packaging bag comprising the packaging material according to Item 1, wherein the packaging material is formed into a bag in such a manner that the moisture-permeable layer is disposed on the inside of the bag.

Item 12. A package, wherein the packaging bag according to Item 11 stores content.

### EFFECT OF THE INVENTION

According to a packaging material of the present invention, a bag for packaging medicinal product can be suitably produced with, for example, the use of the packaging material. In a bag for packaging medicinal product 1 of the present invention as shown in FIG. 1, the moisture in space 7 permeates through the innermost moisture-permeable layers 6 and is allowed to reach moisture-absorption layers 5. The moisture that reaches the moisture-absorption layers is then absorbed into an absorbent contained in the moisture-absorption layers 5. Shielding layers 4 prevent the moisture from leaking outside.

In particular, in the packaging material or the bag for packaging medicinal product of the present invention, the use of polyacrylonitrile as a resin component of the second composition can attain higher moisture permeability, even when it has the same thickness as that of other materials. Therefore, excellent strength as a packaging material or a bag for packaging medicinal product can be ensured.

With the use of the bag for packaging medicinal product of the present invention, an equilibrium humidity of 25% to 35% RH under a 25° C. temperature condition can be achieved. When the moisture absorption value is adjusted within the range mentioned above, the humidity in the space 7 within the range suitable for a medicinal product 3 can be maintained more definitively; thereby, the deposition of the active ingredient contained in the medicinal product 3 is prevented more effectively. Additionally, medicinal performance, shape retention properties, adhesiveness, etc. may also be effectively retained. Accordingly, the use of the bag for packaging medicinal product of the present invention contributes to the long-term stability (storage stability) of the medicinal product 3.

Further, since a desiccant is not necessarily required, the production process can be simplified, and the product can be reduced in cost and size.

### BRIEF DESCRIPTION OF THE DRAWINGS

FIG. 1 is a sectional view of a representative example of the packaging material (or the bag for packaging medicinal product) of the present invention.

FIG. 2 is a graph showing a relationship between the time and water adsorption rate of the bag for packaging medicinal product of Example 1.

### EXPLANATION OF REFERENCE NUMERALS

1. Bag for Packaging Medicinal Product
2. Packaging Material (Packaging Sheet)
3. Medicinal Product
4. Shielding Layer
5. Moisture-Absorption Layer
6. Moisture-Permeable Layer
7. Space

### BEST MODE FOR CARRYING OUT THE INVENTION

### 1. Packaging Material

A packaging material of the present invention comprises at least a moisture-permeable layer, a moisture-absorption layer, and a shielding layer laminated sequentially, wherein:

(1) the moisture-absorption layer is formed of a first composition comprising a moisture absorbent and a resin component;

(2) the moisture-permeable layer is formed of a second composition comprising a resin component; and

(3) the first composition contains a moisture absorbent in a proportion of 15 wt. % to 60 wt. %.

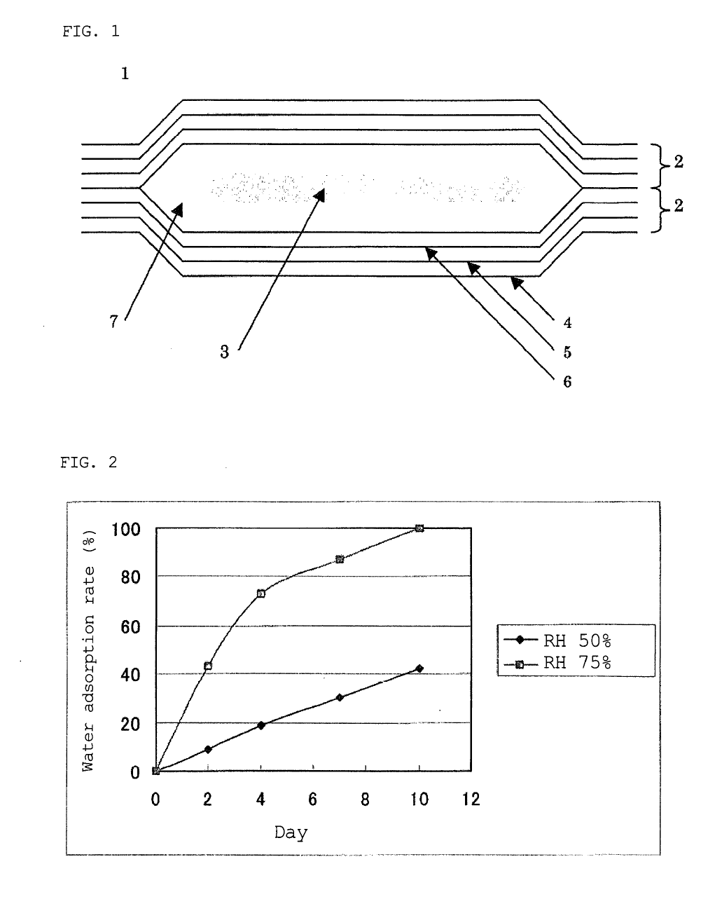

FIG. 1 shows a representative example of embodiments of the packaging material and bag for packaging medicinal product of the present invention. FIG. 1 shows a bag for packaging medicinal product 1 comprising two sheets of packaging material 2 (packaging sheets) laminated in such a manner that each of moisture-permeable layers 6 is disposed on the inside. Two sheets of the packaging material 2 are heat-sealed so as to form a bag, leaving space 7 for medicinal product 3 to be stored. When the medicinal product 3 is to be put in the bag after completion of the production of the bag for packaging medicinal product 1, the packaging material is subjected to partial heat-sealing to form a bag, while leaving an opening (not shown) from which the medicinal product 3 is inserted. The medicinal product 3 inserted into space 7 of the bag for packaging medicinal product 1 is sealed by heat-sealing the packaging material 2.

One example (embodiment) of the packaging material 2, which forms the bag for packaging medicinal product 1, include a laminate sequentially comprising: a moisture-permeable layer 6 comprising PAN (a second composition); a moisture-absorption layer 5 comprising a first composition containing LDPE and a moisture absorbent; and a shielding layer 4 comprising an aluminum foil and an HDPE layer (or a PET layer) (the layer configuration thereof is not shown). In this embodiment, it is preferable that the thicknesses of each layer of (1) the HDPE layer or PET layer, (2) the aluminum foil, (3) the moisture-absorption layer 5, and (4) the moisture-permeable layer 6, be respectively 1) about 9 μm to about 30 μm, (2) about 5 μm to about 30 μm, (3) about 10 μm to about 80 μm, and (4) about 10 μm to about 40 μm.

The total thickness of the packaging material 2 is usually 180 μm or less, and is particularly preferably about 34 μm to about 180 μm. Such a range further ensures the achievement of the aforesaid moisture absorption value. A packaging material with a total thickness of about 180 μm or less allows a miniaturized packaged medicinal product to be provided.

The usage of the packaging material 2 is not limited to packaging bags. Examples include cover materials for various containers. When used as a packaging bag, etc., the content thereof is not limited, and may be food, electronic parts, chemical products, etc., in addition to medicinal products.

Hereinafter, the structure of each layer of the packaging material in accordance with the present invention is explained. A known lamination method may be applied to each layer. Examples of lamination methods include a dry lamination method, an extrusion lamination method, a co-extrusion method, a wet lamination method, a heat lamination method, and the like.

### Moisture-Absorption Layer

A moisture-absorption layer is formed of a first composition containing a moisture absorbent and a resin component. The proportion of the moisture absorbent is 15 wt. % to 60 wt. %, and preferably 30 wt. % to wt. 40%, based on the first composition. When the moisture absorbent proportion in the moisture-absorption layer 5 is less than 15 wt. %, an equilibrium humidity in the range between 25% and 35% RH cannot be maintained, resulting in a failure to provide the optimal environment for storing the content. When the moisture absorbent proportion is more than 60 wt. %, maintaining sealing performance may become difficult when heat-sealing the packaging material 2.

Usable moisture absorbents may be either organic or inorganic moisture absorbents. Preferable examples include oxides such as calcium oxide, magnesium oxide, silicon oxide (silica gel), and the like; and metal salts such as calcium carbonate and magnesium sulfate, and the like. Additionally, zeolite etc. may also be used. These may be in either hydrate or anhydride form. Magnesium sulfate is preferably used as such a moisture absorbent since the equilibrium humidity of magnesium sulfate is suitable for the medicinal product 3, and has excellent handleability. The magnesium sulfate is often used in the form of a hydrate; and the bag for packaging medicinal product 1 has a moisture-absorption function. It is therefore preferable to use a low hydration number magnesium sulfate.

Such moisture absorbents are usually used in powder form. The mean particle size thereof can be suitably adjusted within the range of about 4 μm to about 6 μm.

Preferable examples of the resins include, but not limited to, low-density polyethylene (LDPE), polypropylene, ethylene vinyl acetate, and the like. In particular, when LDPE is employed as a matrix, the moisture absorbent contained in the aforesaid proportion can be uniformly distributed throughout the moisture-absorption layer 5. Further, LDPE is excellent in moisture permeability; therefore, the moisture passed through the moisture-permeable layer 6 can readily spread into the moisture-absorption layer 5. As a result, the water molecule and the moisture absorbent in the moisture-absorption layer 5 are allowed to frequently come into contact with each other, resulting in the moisture being easily absorbed by the moisture absorbent.

The thickness of the moisture-absorption layer may be suitably determined according to the types, etc. of the medicinal product, but it is preferably 10 μm to 80 μm, and more preferably 10 μm to 50 μm. Setting the thickness within such a range further ensures the achievement of the aforesaid moisture absorption value.

### Moisture-Permeable Layer

A moisture-permeable layer, through which moisture permeates, is formed of a second composition containing a resin. It is preferable to use polyacrylonitrile (PAN) as such a resin in the second composition. The use of polyacrylonitrile, which has excellent moisture permeability compared to HDPE, etc., further ensures exertion of moisture permeability in the latter range mentioned below.

The second composition may contain other components in addition to the aforesaid resins; it is also possible that the second composition contains a resin component alone.

The moisture-permeable layer 6 of the packaging material 2 preferably has a moisture permeability of 40 to 120 g/m²/day. The use of PAN, which has excellent moisture permeability compared to HDPE, etc., to form the moisture-permeable layer 6 further ensures the achievement of the moisture permeability value in the range mentioned above. When HDPE, etc. is used, the layer must be extremely thin to attain the moisture permeability in the aforesaid range, which causes a deterioration of strength of the moisture-permeable layer 6 that renders it unpractical. However, the use of PAN can effectively retain the strength of the moisture-permeable layer 6, since PAN ensures the suitable layer thickness. When the moisture permeability of the moisture-permeable layer 6 is less than 40 g/m²/day, the desired moisture-absorption effect of the moisture absorbent may not be obtained. A moisture permeability of more than 120 g/m²/day may cause dryness in the space 7, which is not desirable for the medicinal product 3.

The thickness of the moisture-permeable layer may be suitably determined according to the types of the medicinal product, etc., but it is preferably 10 μm to 40 μm, and more preferably 10 μm to 30 m. Such a thickness range further ensures the achievement of the aforesaid moisture absorption value.

### Shielding Layer

A shielding layer is mainly used for shielding the contents (the medicinal product) from the outside air. Usable materials for the layer are not critical as long as they have shielding effects, and may be those employed for known packaging materials for medicinal product, etc. Examples include metals (preferably aluminum), etc.; and resins such as polyethylene terephthalate (PET), high-density polyethylene (HDPE), polypropylene, polyester, polyamide (nylon), vinyl chloride, ethylene-vinyl alcohol copolymer, ethylene-vinyl acetate, etc. These sheets or foils may be used, as such a shielding layer, singly or in a combination of two or more laminated. On the outside of the shielding layer, cellophane, paper, etc. may be laminated, as necessary.

Such a shielding layer is preferably formed of at least one member selected from a metallic foil, a polyethylene terephthalate film (PET), and a high-density-polyethylene (HDPE) layer. Low-density polyethylene (LDPE) has excellent moisture permeability compared to high-density resins such as HDPE, etc. Further, a shielding layer formed of at least one member selected from a metallic foil, a HDPE layer, and a PET layer, remarkably enhances its blocking effect against moisture.

When the bag for packaging medicinal product 1 is used to package a medicinal product that requires no light blockage at a specific wavelength, a material transparent to such wavelength light may be used to form the bag. However, it is preferable to use a material having a blocking effect against far-red light, infrared light, and ultraviolet radiation, from a viewpoint of the stable retention of the active ingredients of the medicinal product.

It is also possible to use resins other than LDPE as the resin forming the moisture-absorption layer 5. Such a resin preferably has a moderate permeability to moisture, as well as excellent dispersibility of a moisture absorbent. Examples of such resins include polypropylene, ethylene-vinyl acetate, and the like. The moisture-absorption layer can be used as a blown film in combination with an interposition layer. As such an interposition layer, layers having a thickness of about 10 μm to 30 μm, such as LDPE, HDPE, PET, etc., may be utilized.

The thickness of the shielding layer varies depending on the material, etc., used for the shielding layer, but it is usually about 14 μm to about 60 μm, and preferably 15 μm to 40 μm. Setting the thickness in such a range further ensures the achievement of the aforesaid moisture absorption value.

### Other Layers

In the packaging material of the present invention, one or more other layers may further be laminated as necessary, in addition to the layers mentioned earlier. Examples include adhesive layers, coloring layers, printing layers, evaporated layers, primer layers, surface protection layers (overcoat layers), adhesion layers, and the like. These layers may be those used for known packaging materials.

### Moisture Absorption Property

With respect to the moisture absorption properties of the packaging material of the present invention, the equilibrium humidity is preferably 25% to 35% RH at a temperature of 25° C. A packaging material having such moisture-absorption values is less likely to adversely affect the contents, even when the packaging material contains a desiccant or a moisture absorbent that absorbs moisture more than necessary. When the equilibrium humidity is 40% RH or more, the moisture (a water molecule) contained in the air of the space 7 of the bag body is not sufficiently absorbed by the packaging material 2. This causes the components of the medicinal product 3 to be easily deposited. The packaging material, which absorbs moisture until the equilibrium humidity becomes 10% RH or less (in particular 0% RH), may not be suitable for the medicinal product 3, because the moisture in the space 7 is excessively absorbed by the packaging material, causing dryness therein. The dryness may result in decreased properties of the medicinal product 3 because of evaporation of the adhesive or volatile components of the medicinal product.

### 2. Bag for Packaging Medicinal Product

The bag for packaging medicinal product of the present invention comprises the packaging material of the present invention mentioned earlier, and the packaging material is formed into a bag in such a manner that the moisture-permeable layer is disposed on the inside of the bag.

FIG. 1 shows the bag for packaging medicinal product 1, in which each of the two moisture-permeable layers of the packaging material 2 is laminated to be on the inside. Two sheets of the packaging material are subjected to thermal binding (heat-sealing), leaving a portion to be used as an opening of the bag for packaging medicinal product; thereby, a bag body is formed. When the content is inserted after production of the bag body, the packaging material is heat-sealed, leaving space (an opening portion) for the content to be stored.

In particular, when the moisture permeability of the moisture-permeable layer and the proportion of a moisture absorbent in the moisture-absorption layer are controlled within the ranges mentioned above, the moisture absorption value of the packaging material may be maintained with the equilibrium humidity being 25% to 35% RH at a temperature of 25° C. When the equilibrium humidity of this packaging material is 40% RH or more, the moisture in the internal space of the bag for packaging medicinal product is not sufficiently absorbed by the packaging material. Therefore, the component of the medicinal product contained in such a bag is easily deposited.

The bag for packaging medicinal product of the present invention is preferably formed using heat-sealing of the packaging material. The heat-seal strength is preferably in the range of 5 N/15 mm (width) to 20 N/15 mm (width). Such a range strengthens the sealing of the bag, further ensuring the prevention of outside moisture permeation inside the bag. When each layer of the packaging material of the bag is mainly formed of a thermoplastic resin such as LDPE, PAN and the like, heat-sealing is easily conducted and the sealing is strengthened. A heat-seal strength of less than 5 N/15 mm may cause the sealed portion to peel easily due to the surrounding environment at the time of storage. A heat-seal strength of more than 20 N/15 mm may result in an undesirably cut-off sealed portion, etc.

### 3. Packaged Medicinal Product

The present invention encompasses a packaged medicinal product in which the bag for packaging medicinal product of the present invention described above stores a medicinal product containing a medicinal component.

The production method of the packaged medicinal product is not particularly limited. Examples of the methods may involve laminating the packaging material 2, which is in the form of sheets (films), in such a manner that the moisture-permeable layers 6 are disposed on the inside, while sandwiching patch 3; applying heat to a desired portion thereof with a sealer, etc. usually used to seal the portion (i.e., heat-sealing); and, if required, cutting off the outline of the sealed portion.

The heat-seal strength therefor is preferably 5 N/15 mm (width) to 20 N/15 mm (width). A heat-seal strength of less than 5 N/15 mm (width) may cause the sealed portion to peel easily due to the surrounding environment at the time of storage. A heat-seal strength of more than 20 N/15 mm may result in an undesirably cut-off sealed portion, etc.

Types of the bag for packaging a medicinal product for produce are not limited. Known types, such as three-side seal bags, four-side seal bags, gusset bags, self-supporting bags, and pillow bags, etc. may be suitably selected.

The heat-sealing method is not limited to the hot plate method. For example, known methods such as ultrasonic sealing, induction-heat sealing, etc., may be widely employed.

In the embodiment above, two sheets of the packaging material 2 are laminated in such a manner that the moisture-permeable layers 6 are disposed on the inside and heat-sealed, thereby forming a bag. However, depending on the content, various types of packaging bags may be produced by laminating a single sheet of the packaging material 2 in combination with a known general packaging material. It is also possible to produce a three-side seal bag, a pillow bag, etc. using a single sheet of the packaging material 2.

### EXAMPLES

Hereinafter, the present invention is explained in more detail with reference to Examples and Comparative Example. However, the present invention is not limited to these Examples.

The value shown in the Examples was respectively measured according to the following methods.

### Moisture Permeability

Moisture permeability is measured in accordance with Testing Method for Water Permeability prescribed in JIS Z 0208 (1976). A permeation cell containing an anhydrous calcium chloride is sealed using a sample in the form of a film (the moisture permeable portion: 28.274 cm²). The sealed permeation cell is weighed, while outside conditions of a 40° C. temperature and a relative humidity of 90% are maintained for 1 day to several days. The moisture permeability value is thereby calculated from the relation represented in the following Formula (1).

η=240×m/t/S (1)

wherein η represents a moisture permeability (g/m²/day); S represents a moisture permeation area (cm²); t represents the time (hr) spent for weighing; and m represents an increased weight (mg) while weighing (during the time t (hr).

### Equilibrium Humidity

Equilibrium humidity is a relative humidity rendered equilibrated in an enclosed space where the packaging material (specimen) in the form of a film is allowed to stand under the conditions of a 25° C. temperature and a high humidity (the humidity is an absolute humidity not exceeding the maximum moisture absorption amount of the specimen). Specifically, the equilibrium humidity is a relative humidity when the rate of moisture absorption and desorption of the specimen becomes constant, and when the relative humidity in the enclosed space apparently becomes constant (equilibrium).

### Low-Density Polyethylene/High-Density Polyethylene

Low-density polyethylene (LDPE) is a polyethylene whose specific gravity bears a relation to following Formula (2):

0.91≦ρ<0.94 (2)

wherein ρ represents the specific gravity (g/cm³) of the polyethylene (the same also applies to the following Formula). High-density polyethylene (HDPE) is a polyethylene whose specific gravity bears a relation to following Formula (3):

0.94≦ρ<0.96 (3)

### Heat-Seal Strength

The “Heat-Seal Strength” of the present invention is expressed in load when a 15 mm width×200 mm length sample is subjected to a T-peel test with a speed of 200 mm/min.

### Example 1

Production of a bag for packaging medicinal product: the following layers are laminated (by a dry lamination method using a polyurethane adhesive, unless otherwise stated) in the order shown below. Then, the surface of the shielding layer was coated with cellophane (20 μm in thickness); the packaging material was thereby produced.

Moisture-Permeable Layer: PAN (thickness: 30 μm; moisture permeability: 70 g/m²/day)

Interposition Layer 1: LDPE (thickness: 10 μm)

Moisture-Absorption Layer: LDPE (thickness: 30 μm; 30 wt. % of magnesium sulfate is contained)

Interposition Layer 2: LDPE (thickness: 20 μm)
The interposition layer 1, moisture-absorption layer, and interposition layer 2 are together a three-layer blown film.

Shielding Layer: aluminum foil (thickness: 9 μm):PET (thickness: 12 μm)

The moisture absorption property of this packaging material was measured as the equilibrium humidity of 30% RH (+5%) at 25° C. Sequentially, two sheets of the packaging material (a 75 mm width×95 mm length rectangle) were heat-sealed (a three-side seal; temperature: 160° C.; time: 1 second; pressure: 0.2 MPa; seal width: 10 mm) in such a manner that both of the moisture-permeable layers were disposed on the inside to form a bag; thereby, the bag for packaging medicinal product was obtained.

### Example 2

Production of a bag for packaging medicinal product: the following layers are laminated in the order shown below. Then, the surface of the shielding layer was coated with cellophane (20 μm in thickness); the packaging material was thereby produced.

Moisture-Permeable Layer: PAN (thickness: 30 μm; moisture permeability: 70 g/m²/day)

Interposition Layer 1: LDPE (thickness: 10 μm)

Moisture-Absorption Layer: LDPE (thickness: 30 μm; 42 wt. % of magnesium sulfate is contained)

Interposition Layer 2: LDPE (thickness: 20 μm)
The interposition layer 1, moisture-absorption layer, and interposition layer 2 are together a three-layer blown film.

Shielding Layer: aluminum foil (thickness: 15 μm):PET (thickness: 25 μm)

The moisture absorption property of this packaging material was measured as the equilibrium humidity of 30% RH (+5%) at 25° C. Sequentially, two sheets of the packaging material (a 75 mm width×95 mm length rectangle) were heat-sealed (a three-side seal; temperature: 160° C.; time: 1 second; pressure: 0.2 MPa; seal width: 10 mm) in such a manner that both of the moisture-permeable layers were disposed on the inside to form a bag; thereby, the bag for packaging medicinal product was obtained.

### Example 3

Production of a bag for packaging medicinal product: the following layers are laminated in the order shown below. Then, the surface of the shielding layer was coated with cellophane (20 μm in thickness); the packaging material was thereby produced.

Moisture-Permeable Layer: PAN (thickness: 30 μm; moisture permeability: 70 g/m²/day)

Moisture-Absorption Layer: LDPE (thickness: 30 μm; 18 wt. % of magnesium sulfate is contained)

Interposition Layer: LDPE (thickness: 10 μm)

The moisture-absorption layer and interposition layer are together a two-layer blown film.

Shielding Layer: aluminum foil (thickness: 6 μm):HDPE (thickness: 12 μm)

The moisture absorption property of this packaging material was measured as the equilibrium humidity of 30% RH (±5%) at 25° C. Sequentially, two sheets of the packaging material (a 75 mm width×95 mm length rectangle) were heat-sealed (a three-side seal; temperature: 160° C.; time: 1 second; pressure: 0.2 MPa; seal width: 10 mm) in such a manner that both of the moisture-permeable layers were disposed on the inside to form a bag; thereby, the bag for packaging medicinal product was obtained.

### Comparative Example 1

A bag for packaging medicinal product was obtained in the same manner as in Example 1, except that LDPE with a thickness of 10 μm, having a moisture permeability of 60 g/m²/day, was used in place of the moisture-permeable layer of Example 1.

### Test Example 1

The three-side seal bag (a 75 mm width×95 mm length rectangle) obtained in Example 1 was allowed to stand in incubators with a 25° C. temperature and relative humidities of 50% and 75% for 2 to 10 days. The water adsorption rates thereof were then measured using a Karl Fischer Moisture Meter (“MKC210”; produced by Kyoto Electronics Manufacturing Co., Ltd. (moisture evaporator: ADP-351)). FIG. 2 shows the results.

(1) The nitrogen gas flow rate in the moisture evaporator was adjusted to 200 ml.

(2) The temperature in the moisture evaporator was set to 150° C.

(3) A back purge and a cell purge of the moisture meter were conducted.

(4) The specimen was cut to a 50 mm width×50 nm length size (rectangle).

(5) The specimen was weighed using an electrobalance.

(6) After the moisture meter was prepared for use, the specimen (50 mm×50 mm) was cut into pieces about 5 mm by about 5 mm in size. The cut specimen pieces were then placed in an aluminum foil-lined tray inside the moisture evaporator. Thereafter, the start button was pressed.

(7) After the measurement, the specimen was weighed again.

(8) The moisture value was printed out to read the value. (Unit: μg)

(9) The water adsorption rate was calculated in accordance with the following formula.

Water Adsorption Rate(%)={(measurement results)×400}/10⁶}/maximum amount of adsorption×100

Maximum Amount of Adsorption=9 g/m²

### Test Example 2

### Adsorbed Amount of Medicinal Component

Twenty sheets (each sheet 42 mm×65 mm in size) of commercially available patches (Salonpas Ae; trade name) were inserted through an opening into the three-side seal bag for packaging medicinal product produced in the Examples above and the Comparative Example (75 mm width×95 mm length, rectangle). Then, the opening was completely sealed by thermal binding. Thereafter, the bag was allowed to stand for 1 week in a storehouse under the conditions of 60±2° C. and a relative humidity of 75%. Each amount adsorbed by the bag with respect to dl-camphor, l-menthol, and methyl salicylate was measured using a gas chromatograph (GC/MS-SIM method). The measured value was converted into an adsorbed amount per unit area (100 cm²), thereby obtaining the results of each adsorbed amount. GC/MS was carried out in accordance with the following steps (1) to (4).

### (1) Preparation of Sample Solution

Each bag for packaging a medicinal product was opened, and the medicinal product was taken out of the bag. A 50 ml quantity of ethanol was introduced into the bag, and the bag was irradiated with a supersonic wave for 10 minutes. The ethanol in the bag was transferred to a 100 ml volumetric flask. Then, another amount of ethanol (30 ml) was introduced into the bag, and the bag was again irradiated with a supersonic wave for 10 minutes. The ethanol in the bag was again transferred to the volumetric flask. The inside of the bag was again washed with ethanol, and the wash liquid was transferred to the volumetric flask. Then, additional ethanol was added to the flask, to a total amount of 100 ml. Thereby, 4 types of sample solutions corresponding to 4 types of the bags for packaging medicinal product were prepared.

### (2) Preparation of Standard Solution

With regard to medicament components (dl-camphor, l-menthol, methyl salicylate), 5 standard solutions were each prepared in concentrations ranging from about 0.035 μg/ml to about 7 μg/ml (equivalent to about 5 μg to about 1 mg/100 cm²).

### (3) GC/MS Operating Condition

Device: HP-6890/5937MSD

Column: DB-WAX (film thickness: 0.25 μm; inside diameter: 0.25 mm; length: 30 m)

Column Temperature: 110° C.

Inlet Temperature: 250° C.

Interface Temperature: 250° C.

Ionizing method: EI method

Measurement mode: SIM method

Measured ion mass (m/Z):
dl-camphor; 95,123
l-menthol; 71,123
methyl salicylate; 120,152

Ionization Voltage: 70 eV (EMT: STUNE Value)

Carrier Gas: Helium, 1 ml/min

Injection Method Split method (split ratio=10:1)

Injection volume: 1 μl

### (4) Measurement of Adsorbed Amount

The amounts of the medicament components contained in the sample solutions and standard solutions prepared in the above process were measured according to the aforesaid GC/MS. A calibration curve was prepared based on the measurement results with respect to the standard solutions. The amounts of the medicament components contained in the sample solutions were then calculated based on the calibration curve. Regarding Comparative Example 1 (no PAN layers used), the measurement using the sample solutions prepared as above resulted in the detection of the medicament components in an amount exceeding the upper limit of the calibration curve. Therefore, the sample solutions of Comparative Example 1 were diluted 20 times with ethanol to conduct the measurement again. Each adsorbed amount (μg) per 100 cm² was calculated based on the calculated concentration level of each medicament component. Table 1 shows the results.

As is clear from Table 1, a larger amount of the medicinal components was adsorbed when a PAN layer was not used as a moisture-permeable layer than when a PAN layer was used as a moisture-permeable layer (i.e., when a PAN layer is used as a moisture-permeable layer, the adsorbed amount of medicinal components decreases).

### Test Example 3

A sample 15 mm width×200 mm length in size was produced separately to measure the heat-seal strength. Two sheets of the sample were subjected to heat-sealing (the heat-sealing conditions were the same as those mentioned above) a 100 mm length from one edge so that the moisture-permeable layers were disposed on the inside. Then, the sample was subjected to a T-peel test with a speed of 200 mm/min; thereby, the heat-seal strength was expressed in load. Table 1 shows the results.

TABLE 1

| | Adsorbed Amount μg/100 cm² | | | Heat-Seal |
|---|---|---|---|---|
| | | | methyl | Strength |
| | dl-camphor | l-menthol | salicylate | N/15 mm width |
| Example 1 | <5 | 14.0 | 30.0 | 10 |
| Example 2 | <5 | 16.3 | 34.3 | 11 |
| Example 3 | <5 | 12.5 | 25.2 | 10 |
| Comparative | 644 | 3053 | 10663 | 6 |
| Example 1 | | | | |

In Table 1, “<5” refers to a value less than 5.

As shown in the results above, the products of the present invention (Examples 1 to 3) have superior effects regarding the adsorbed amount and heat-seal strength, compared to Comparative Example 1.

1. A packaging material comprising at least a moisture-permeable layer, a moisture-absorption layer, and a shielding layer laminated sequentially, wherein:
(1) the moisture-absorption layer is formed of a first composition comprising a moisture absorbent and a resin component;
(2) the moisture-permeable layer is formed of a second composition comprising a resin component; and
(3) the first composition contains a moisture absorbent in a proportion of 15 wt. % to 60 wt. %.

2. The packaging material according to claim 1, having a moisture absorption property of an equilibrium humidity from 25% to 35% RH at a temperature of 25° C.

3. The packaging material according to claim 1, wherein the resin component of the first composition is a low-density polyethylene.

4. The packaging material according to claim 1, wherein the resin component of the second composition is polyacrylonitrile.

5. The packaging material according to claim 1, wherein the moisture-absorption layer has a thickness of 10 μm to 80 μm.

6. The packaging material according to claim 1, wherein the moisture-permeable layer has a thickness of from 10 μm to 40 μm.

7. A bag for packaging a medicinal product, comprising the packaging material according to claim 1, wherein the packaging material is formed into a bag in such a manner that the moisture-permeable layer is disposed on the inside of the bag.

8. The bag for packaging a medicinal product according to claim 7, wherein the packaging material is heat-sealed to form a bag.

9. The bag for packaging a medicinal product according to claim 8, wherein the heat-seal strength is from 5 N/15 mm to 20 N/15 mm.

10. A packaged medicinal product, wherein the bag for packaging a medicinal product according to claim 7 stores a medicinal product containing a medicinal component.
